(19) United States
(12) Patent Application Publication
(10) Pub. No.: US 2017/0276567 A1
(43) Pub. Date: Sep. 28, 2017

(54) INFORMATION PROCESSING APPARATUS, INFORMATION PROCESSING METHOD, AND PROGRAM

(71) Applicant: NEC Corporation, Tokyo (JP)

(72) Inventors: Yasuhiro SOGAWA, Tokyo (JP); Nobuhiro MIKAMI, Tokyo (JP)

(73) Assignee: NEC Corporation, Tokyo (JP)

(21) Appl. No.: 15/456,727

(22) Filed: Mar. 13, 2017

(30) Foreign Application Priority Data
Mar. 22, 2016 (JP) 2016-057158

(51) Int. Cl. G01M 5/00

(52) U.S. Cl. CPC G01M 5/0033; G01M 5/0008

(57) ABSTRACT

An information processing apparatus comprises: a processor configured to: estimate a soundness degree of a checkup-object structure from an inspection result of the checkup-object structure, based on a model generated by using an inspection result of a learning-object structure and a soundness degree of the learning-object structure; and present in a recognizable manner an erroneous determination possibility indicating a possibility that a soundness degree determined from the inspection result of the checkup-object structure is erroneous, based on the estimated soundness degree of the checkup-object structure.

This application is based upon and claims the benefit of priority from Japanese Patent Application No. 2016-057158, filed on Mar. 22, 2016, the disclosure of which is incorporated herein in its entirety by reference.

### TECHNICAL FIELD

The present invention relates to an information processing apparatus, an information processing method, and a program.

### BACKGROUND ART

In maintenance of a structure, such as a bridge, a tunnel, and a road, an inspector periodically performs inspection by visual observation, hammering, and the like. Depending on a damage status of a structure recognized as a result of the inspection, soundness degree determination of the structure is carried out on the basis of knowledge. Since simultaneous repair of all damages present in many structures is difficult due to cost and human resource restrictions, a manager of structures makes repair plans for the structures on the basis of a result of the soundness degree determination obtained from the inspection result. Therefore, the soundness degree determination is very important. For example, a system that predicts degradation of a structure by using the soundness degree determined by an inspector as mentioned above is described in PTL 1.

Furthermore, for the purpose of increasing reliability of the soundness degree determination and reducing a risk of overlooking an object to be repaired, it is a general practice to carry out multiple rechecks, such as double-check and triple-check, of a result of the soundness degree determination by a plurality of experts. In this case, a skilled expert or a group of experts receives a soundness degree determined from an inspection result by an inspector and then checks the soundness degree and damage information indicated by the inspection result. When the soundness degree determined by an inspector is considerably different from findings by an expert, the soundness degree determination carried out by the inspector is regarded as erroneous determination and then corrected by the expert.

### CITATION LIST

### Patent Literature

### [PTL 1] Japanese Laid-open Patent Publication No. 2006-323741

### SUMMARY

An object of the present invention is to provide an information processing apparatus, an information processing method, and a program that are capable of efficiently carrying out a recheck of a result of soundness degree determination.

According to a non-limiting illustrative embodiment, an information processing apparatus comprises: a processor configured to: estimate a soundness degree of a checkup-object structure from an inspection result of the checkup-object structure, based on a model generated by using an inspection result of a learning-object structure and a soundness degree of the learning-object structure; and present in a recognizable manner an erroneous determination possibility indicating a possibility that a soundness degree determined from the inspection result of the checkup-object structure is erroneous, based on the estimated soundness degree of the checkup-object structure.

According to a non-limiting illustrative embodiment, an information processing method comprises: estimating a soundness degree of a checkup-object structure from an inspection result of the checkup-object structure, based on a model generated by using an inspection result of a learning-object structure and a soundness degree of the learning-object structure; and presenting, in a recognizable manner, an erroneous determination possibility indicating a possibility that a soundness degree determined from an inspection result of the checkup-object structure is erroneous, based on the estimated soundness degree of the checkup-object structure.

According to a non-limiting illustrative embodiment, a non-temporary storage medium stores a program that causes a computer to execute the processes of: estimating a soundness degree of a checkup-object structure from an inspection result of the checkup-object structure, based on a model generated by using an inspection result of a learning-object structure and a soundness degree of the learning-object structure; and presenting, in a recognizable manner, an erroneous determination possibility indicating a possibility that a soundness degree determined from an inspection result of the checkup-object structure is erroneous, based on the estimated soundness degree of the checkup-object structure.

### BRIEF DESCRIPTION OF THE DRAWINGS

FIG. 1 is a block diagram illustrating a characteristic configuration of a first exemplary embodiment.

FIG. 2 is a block diagram illustrating a configuration of a determination support apparatus in the first exemplary embodiment.

FIG. 3 is a block diagram illustrating a configuration of the determination support apparatus realized by a computer in the first exemplary embodiment.

FIG. 4 is a flowchart illustrating an operation of the determination support apparatus in the first exemplary embodiment.

FIG. 5 is a diagram illustrating an example of learned data in the first exemplary embodiment.

FIG. 6 is a diagram illustrating an example of checkup data in the first exemplary embodiment.

FIG. 7 is a diagram illustrating an example of estimated soundness degrees in the first exemplary embodiment.

FIG. 8 is a diagram illustrating an example of determination errors in the first exemplary embodiment.

FIG. 9 is a diagram illustrating an example of an output screen displaying erroneous determination candidates in the first exemplary embodiment.

FIG. 10 is a block diagram illustrating a configuration of a determination support apparatus in a second exemplary embodiment.

FIG. 11 is a flowchart illustrating an operation of the determination support apparatus in the second exemplary embodiment.

FIG. 12 is a diagram illustrating an example of calculated threshold values in the second exemplary embodiment.

FIG. 13 is a diagram illustrating probability of determination of a checkup-object structure as an erroneous determination candidate determination against the estimated soundness degree of the checkup-object structure in the second exemplary embodiment.

FIG. 14 is a block diagram illustrating a configuration of a determination support apparatus in a third exemplary embodiment.

FIG. 15 is a flowchart illustrating an operation of the determination support apparatus in the third exemplary embodiment.

FIG. 16 is a diagram illustrating an example of checkup data in the third exemplary embodiment.

FIG. 17 is a diagram illustrating an example of erroneous determination candidate detection results in the third exemplary embodiment.

FIG. 18 is a diagram illustrating an example of reliability degrees of inspectors in the third exemplary embodiment.

FIG. 19 is a diagram illustrating an example of an output screen displaying erroneous determination candidates in the third exemplary embodiment.

### EXEMPLARY EMBODIMENT

Exemplary embodiments will be described in detail with reference to the drawings. Note that, with regard to exemplary embodiments illustrated in the drawings and the specification, like component elements are given the same reference signs and descriptions thereof are omitted as appropriate.

### First Exemplary Embodiment

A first exemplary embodiment will be described.

First, a configuration of a determination support apparatus 100 in the first exemplary embodiment will be described.

FIG. 2 is a block diagram illustrating a configuration of the determination support apparatus 100 in the first exemplary embodiment. The determination support apparatus 100 is an exemplary embodiment of the information processing apparatus.

Referring to FIG. 2, the determination support apparatus 100 in the first exemplary embodiment includes a determination model generation unit 111, a soundness degree estimation unit 112, a determination error calculation unit 113, an erroneous determination presentation unit 114, a learned data storage unit 115, and a checkup data storage unit 116.

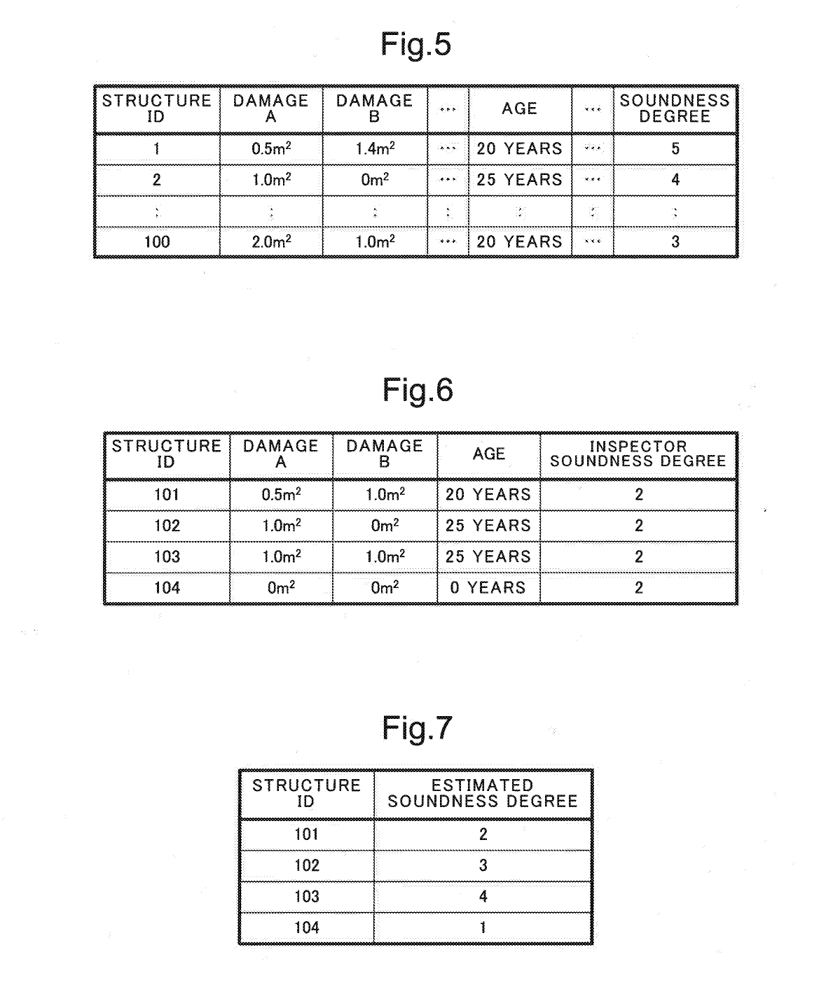

The learned data storage unit 115 stores learned data. The learned data indicates an inspection record of each of one or more learning-object structures and soundness degrees determined for the inspection records. The soundness degrees in the learned data are soundness degrees determined for the inspection records by, for example, skilled experts, skilled expert groups, or the like. FIG. 5 is a diagram illustrating an example of the learned data in the first exemplary embodiment. In the example in FIG. 5, inspection records and soundness degrees are associated separately for each of identifiers of learning-object structures (structure IDs (identifiers)) as learned data. As the inspection records, different magnitudes of damage (“damage A”, “damage B”, . . . ) of the structures and ages of the structures are set. The different damages may be, for example, different kinds of damages, such as water leakage and exposure of reinforcing steel. The different damages may also be, for example, damages to different portions. In this exemplary embodiment, it is assumed that the smaller the value of the soundness degree, the higher the soundness of the structure (the sounder the structure). For example, in FIG. 5, a structure whose structure ID is “2” (hereinafter, referred to as the structure “2”) and whose soundness degree is “4” is higher in soundness than a structure “1” whose soundness degree is “5”. The learned data is saved beforehand in the learned data storage unit 115 by a user or the like.

The checkup data storage unit 116 stores checkup data. The checkup data indicates an inspection record of each of one or more checkup-object structures (objects of recheck of the soundness degrees) and the soundness degrees determined for the inspection records. The soundness degree in the checkup data is a soundness degree determined for each inspection record by, for example, an inspector who has created the inspection record. FIG. 6 is a diagram illustrating an example of the checkup data in the first exemplary embodiment. In the example in FIG. 6, inspection records similar to the inspection records of the learned data and the soundness degrees determined by the inspectors are associated separately for each checkup-object structure ID. The checkup data is also saved beforehand in the checkup data storage unit 116 by a user or the like.

Hereinafter, the soundness degree in learned data is simply termed the “soundness degree” and the soundness degree in the checkup data is termed the “inspector soundness degree”.

It is assumed herein that the soundness degree in the learned data has a lower possibility of being erroneous than the soundness degree in the checkup data, that is, the reliability of the soundness degree in the learned data is higher than the reliability of the inspector soundness degree in the checkup data.

Note that when the reliability of the soundness degree in the learned data is higher than the reliability of the soundness degree in the checkup data, the soundness degree in the learned data may be a soundness degree that is other than the soundness degree determined by a skilled expert or an expert group. Likewise, the soundness degree in the checkup data may also be a soundness degree other than the soundness degree determined by inspectors. For example, the soundness degree in the learned data may be the soundness degree determined by a certain group of experts or inspectors and the soundness degree in the checkup data may be the soundness degree determined by another kind of group.

The determination model generation unit 111 generates a determination model for performing soundness degree determination by using the learned data read from the learned data storage unit 115.

The determination model generation unit 111 generates as a determination model, for example, a mathematical formula that represents a relation between the soundness degree and each item of inspection record in the learned data by a multiple regression analysis method that uses the items of inspection record as explanatory variables and the soundness degree as an objective variable. The determination model generation unit 111 may generate a determination model by a method other than the multiple regression analysis method as long as relations between the soundness degree and the items of inspection records can be represented. For example, the determination model generation unit 111 may generate a determination model by support vector regression or deep learning. Furthermore, the determination model generation unit 111 may generate a determination model by a C4.5 algorithm that represents relations between explanatory variables and an objective variable in an if-then rule form.

The soundness degree estimation unit 112, using the determination model generated by the determination model generation unit 111, estimates a soundness degree of a checkup-object structure included in the checkup data read from the checkup data storage unit 116. Hereinafter, the soundness degree estimated by using the determination model will be also mentioned as the estimated soundness degree. The soundness degree estimation unit 112 estimates the soundness degree, for example, by applying to the determination model the inspection record of the structure included in the checkup data. For example, it is assumed that a rule that “when the inspection record of the structure includes a record that indicates a damage larger than or equal to 1 m², the soundness degree is “3”” has been defined. In this case, the soundness degree estimation unit 112 estimates that the soundness degree of the structure that has a damage larger than or equal to 1 m² according to the checkup data is “3”. Even when the soundness degrees in the learned data and the checkup data are each represented by an integer, the estimated soundness degrees are not limited to integers.

Note that instead of estimating the soundness degree with regard to the checkup data stored in the checkup data storage unit 116, the soundness degree estimation unit 112 may estimate the soundness degree with regard to the checkup data input from a user or the like via a later-described input/output device 103 or the like.

With regard to the checkup-object structure, the determination error calculation unit 113 calculates, as a determination error, a difference dt=St′−St between the soundness degree and the inspector soundness degree that are estimated by the soundness degree estimation unit 112. St′ is the estimated soundness degree of the checkup-object structure. St is the inspector soundness degree.

The erroneous determination presentation unit 114 performs detection of an erroneous determination candidate by comparing a determination error calculated by the determination error calculation unit 113 and a preset threshold value. For example, when the determination error exceeds a range represented by the preset threshold value, the erroneous determination presentation unit 114 determines that there is a possibility that the inspector soundness degree is erroneous (possibility of erroneous determination), and detects the structure as being an erroneous determination candidate.

In the soundness determination regarding a structure, risk of giving damage to a third person is generally higher in a case where the soundness of the structure is erroneously determined as being a soundness higher than the actual soundness than in a case where the soundness thereof is erroneously determined as being a soundness lower than the actual soundness. This is because when the soundness is erroneously determined as being a soundness higher than the actual soundness, a response, such as repair of the structure, or the like, is sometimes not carried out. Therefore, the preset threshold value may, for example, be set in such a way that when the soundness indicated by the inspector soundness degree is higher than the soundness indicated by the estimated soundness degree, it is determined that there is an erroneous determination possibility. For example, when the smaller the value of the soundness degree, the higher the soundness, it is determined that the erroneous determination possibility exists provided that the determination error dt (=St′−St)>a threshold value.

The erroneous determination presentation unit 114 presents the detected erroneous determination candidate to the user or the like via the input/output device 103 or the like.

Note that the determination support apparatus 100 may include a CPU (central processing unit) and a storage medium storing programs. The determination support apparatus 100 may be a computer that operates under the control of programs.

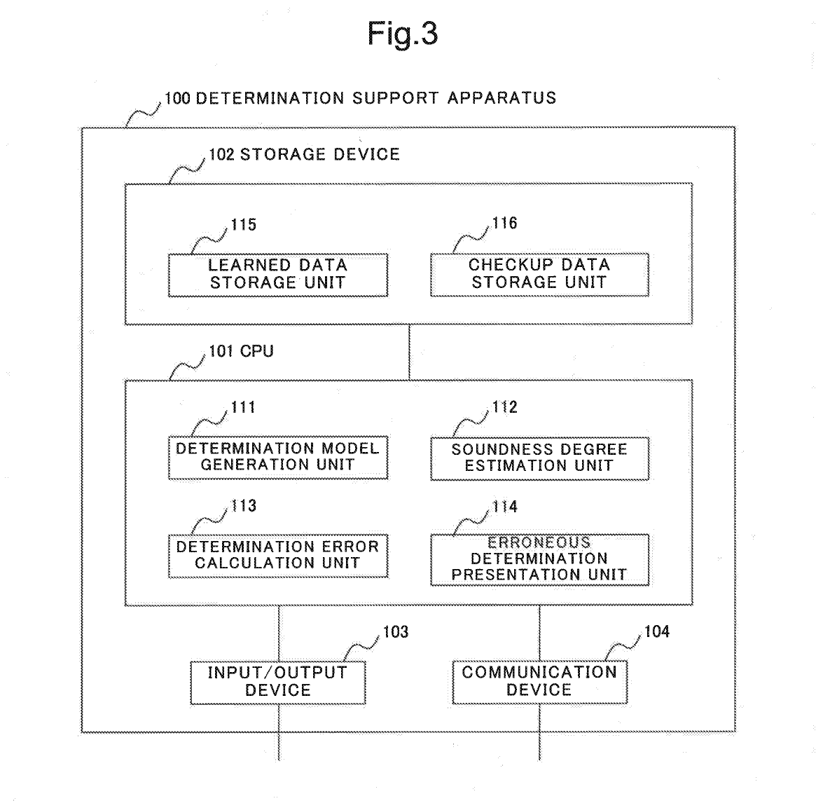

FIG. 3 is a block diagram illustrating a configuration of the determination support apparatus 100 realized by a computer in the first exemplary embodiment.

In this case, the determination support apparatus 100 includes a CPU 101, a memory device 102 (storage medium), such as a hard disk or a memory, an input/output device 103, such as a keyboard or a display, and a communication device 104 that communicates with other devices and the like. The CPU 101 executes programs for realizing the determination model generation unit 111, the soundness degree estimation unit 112, the determination error calculation unit 113, and the erroneous determination presentation unit 114. The memory device 102 stores data of the learned data storage unit 115 and the checkup data storage unit 116. The input/output device 103 performs input of learned data and checkup data from a user or the like and output of erroneous determination candidates to the user. Furthermore, the communication device 104 may receive learned data and checkup data from other devices and the like, or send erroneous determination candidates to other devices and the like.

Furthermore, the various units of the determination support apparatus 100 in FIG. 2 may be realized by electrical circuitry. The electrical circuitry herein conceptually includes a single device, a plurality of devices (multiple devices), a chipset, or a cloud.

Furthermore, the various units of the determination support apparatus 100 in FIG. 2 may be disposed in one physical apparatus. The units of the determination support apparatus 100 may be disposed in two or more physically separate apparatuses that are connected by wire or wirelessly.

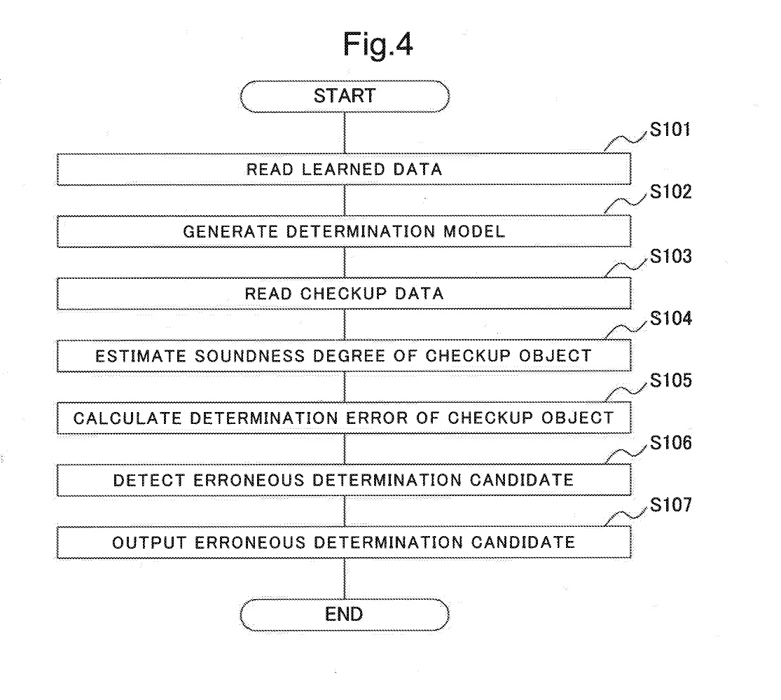

Next, an operation of the determination support apparatus 100 in the first exemplary embodiment will be described. FIG. 4 is a flowchart illustrating an operation of the determination support apparatus 100 in the first exemplary embodiment.

First, the determination model generation unit 111 reads learned data from the learned data storage unit 115 (step S101).

The determination model generation unit 111 generates a determination model by using the read learned data (step S102)

The soundness degree estimation unit 112 reads the checkup data from the checkup data storage unit 116 (step S103).

The soundness degree estimation unit 112 estimates the soundness degree of the checkup-object structure included in the checkup data, by using the determination model (step S104).

With regard to the checkup-object structure, the determination error calculation unit 113 calculates a determination error from a difference between the estimated soundness degree and the inspector soundness degree in the checkup data (step S105).

By comparing the determination error and a preset threshold value, the erroneous determination presentation unit 114 detects an erroneous determination candidate (step S106).

The erroneous determination presentation unit 114 presents (outputs) a structure ID of the erroneous determination candidate (step S107).

Next, a concrete example of an operation of the determination support apparatus 100 in the first exemplary embodiment will be described. It is assumed here that learned data as illustrated in FIG. 5 has been saved in the learned data storage unit 115. Furthermore, it is assumed that checkup data as illustrated in FIG. 6 has been saved in the checkup data storage unit 116. It is assumed that recheck of the soundness degree is performed for structures “101” to “104” included in the checkup data as checkup objects. Furthermore, it is assumed that “1.5” has been set in advance by a user or the like as a threshold value for detecting erroneous determination candidates.

The determination model generation unit 111 executes a linear regression analysis by using the inspection records and the soundness degrees regarding the structures “1” to “100” included in the learned data in FIG. 5. For example, using the soundness degrees as objective variables and the items of the inspection records as explanatory variables, the determination model generation unit 111 generates a determination model represented by a mathematical formula y=ax_A+bx_B+cx_C+d. In the formula, y is the soundness degree, x_A is the magnitude of the damage A, x_B is the magnitude of the damage B, and x_C is the age. Furthermore, a, b, and c are regression coefficients and d is a constant term. The determination model generation unit 111 carries out the calculation with the regression coefficients a, b, and c and the constant term d given as, for example, a=0.5, b=1.5, c=0.05, and d=1.0.

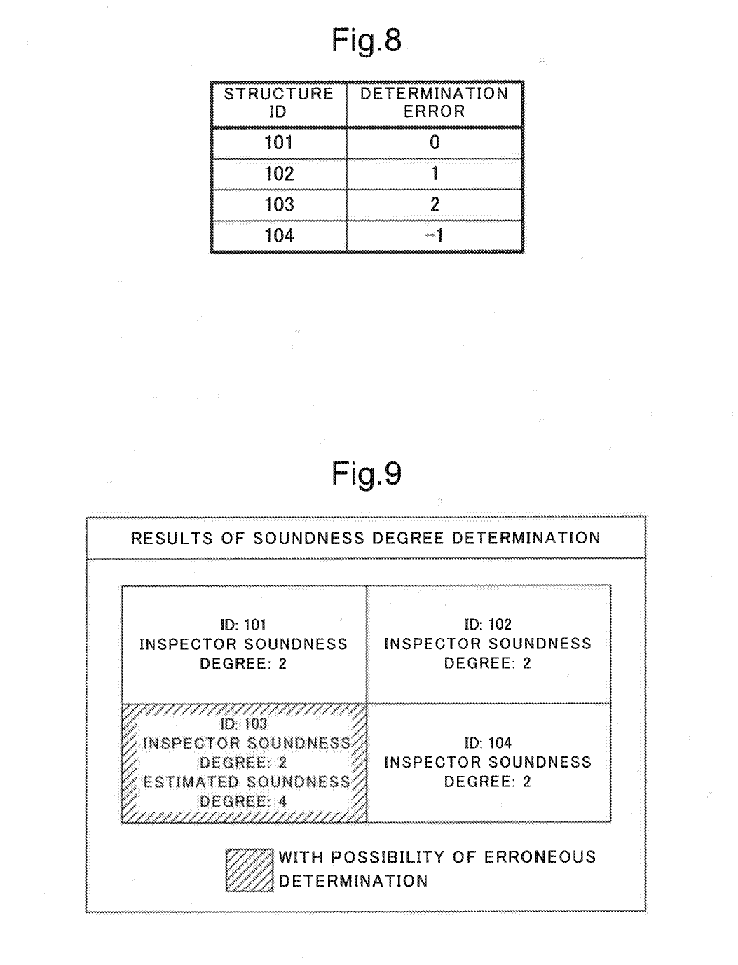

FIG. 7 is a diagram illustrating an example of estimated soundness degrees in the first exemplary embodiment. FIG. 8 is a diagram illustrating an example of determination errors in the first exemplary embodiment.

The soundness degree estimation unit 112, using the determination model, calculates estimated soundness degrees as in FIG. 7, with regard to the structures “101” to “104” included in the checkup data illustrated in FIG. 6.

The determination error calculation unit 113 calculates determination errors as in FIG. 8, with regard to the structures “101” to “104”, by using the estimated soundness degrees in FIG. 7 and the inspector soundness degrees in the checkup data in FIG. 6.

The erroneous determination presentation unit 114 compares the determination errors of the structures “101” to “104” in FIG. 8 with the threshold value of “1.5” and detects the structure “103” as an erroneous determination candidate, whose determination error exceeds the threshold value.

FIG. 9 is a diagram illustrating an example of an output screen displaying erroneous determination candidates in the first exemplary embodiment. In the output screen in FIG. 9, the structure “103” detected as an erroneous determination candidate is indicated differently from the structures “101”, “102”, and “104”, which are not erroneous determination candidates. Furthermore, in association with each of the structures “101” to “104”, the inspector soundness degrees thereof are indicated. Furthermore, as for the structure “103” detected as an erroneous determination candidate, its estimated soundness degree is also indicated.

The erroneous determination presentation unit 114 presents (outputs) the output screen illustrated in FIG. 9 to the user or the like.

On the basis of the output screen illustrated in FIG. 9, the user or the like can efficiently perform the recheck of results of soundness degree determination by narrowing down to the structure that is an erroneous determination candidate.

Note that the erroneous determination presentation unit 114 does not necessarily need to provide an output screen as illustrated in FIG. 9 but needs merely to provide a presentation in such a way that the user or the like can recognize erroneous determination candidates. For example, the erroneous determination presentation unit 114 may present a screen that displays a list of the structure IDs of erroneous determination candidates. Furthermore, the erroneous determination presentation unit 114 may present erroneous determination candidates by a method other than the method that uses a screen, for example, by outputting a file that includes a list of the structure IDs of erroneous determination candidates, or the like.

The operation of the first exemplary embodiment is completed as described above.

Next, a characteristic configuration of the first exemplary embodiment will be described.

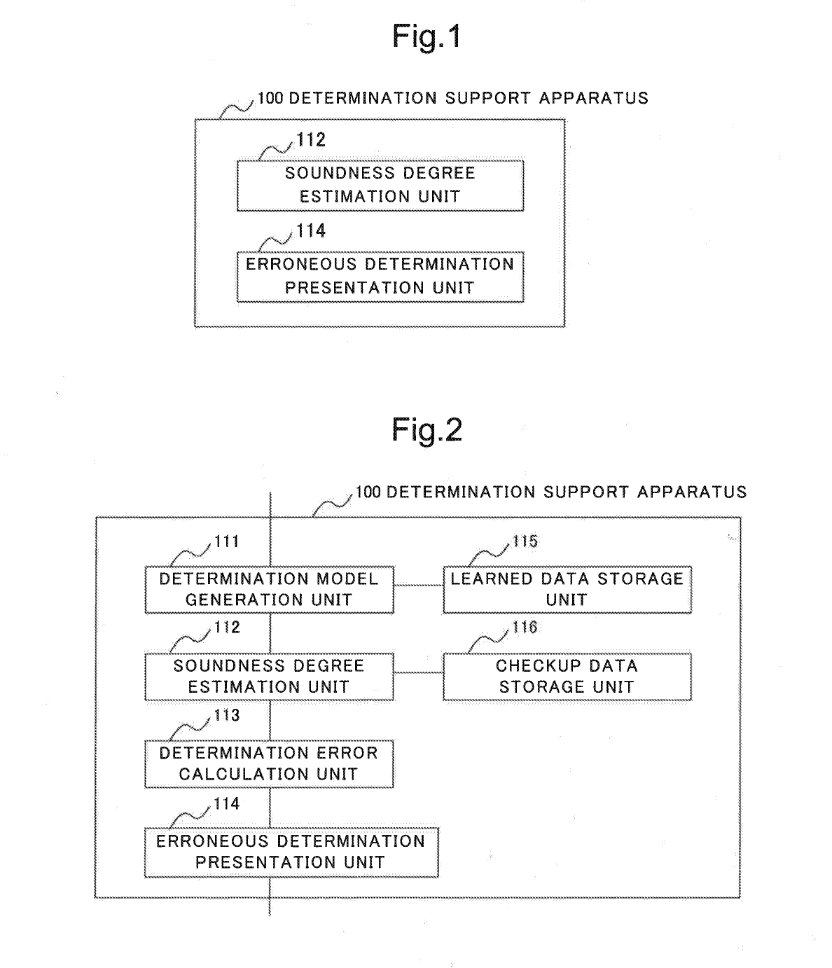

FIG. 1 is a block diagram illustrating a characteristic configuration of the first exemplary embodiment. Referring to FIG. 1, the determination support apparatus 100 includes the soundness degree estimation unit 112 and the erroneous determination presentation unit 114. The soundness degree estimation unit 112 estimates, on the basis of the model generated by using inspection results and the soundness degree of a learning-object structure, the soundness degree of a checkup-object structure from the inspection results of the checkup-object structure. The erroneous determination presentation unit 114 presents, on the basis of the estimated soundness degree of the checkup-object structure, in a recognizable manner an erroneous determination possibility indicating the possibility that the soundness degree determined from the inspection results of the checkup-object structure may be erroneous.

Next, advantageous effects of the first exemplary embodiment will be described.

According to the first exemplary embodiment, recheck of the result of soundness degree determination can be efficiently performed. A reason for this is that the soundness degree estimation unit 112 calculates, on the basis of the determination model, the estimated soundness degree from the inspection results of the checkup-object structure and the erroneous determination presentation unit 114 presents, on the basis of the estimated soundness degree, the erroneous determination possibility indicating the possibility that the inspector soundness degree of the checkup-object structure may be erroneous. Therefore, the user or the like can efficiently recheck the results of the soundness degree determination by narrowing down to structures for which the erroneous determination possibility has been presented (i.e., of which the inspector soundness degrees are low in reliability).

### Second Exemplary Embodiment

Next, a second exemplary embodiment will be described. The second exemplary embodiment is different from the first exemplary embodiment in that a threshold value for detecting erroneous determination candidates is set.

First, a configuration of a determination support apparatus 100 in the second exemplary embodiment will be described.

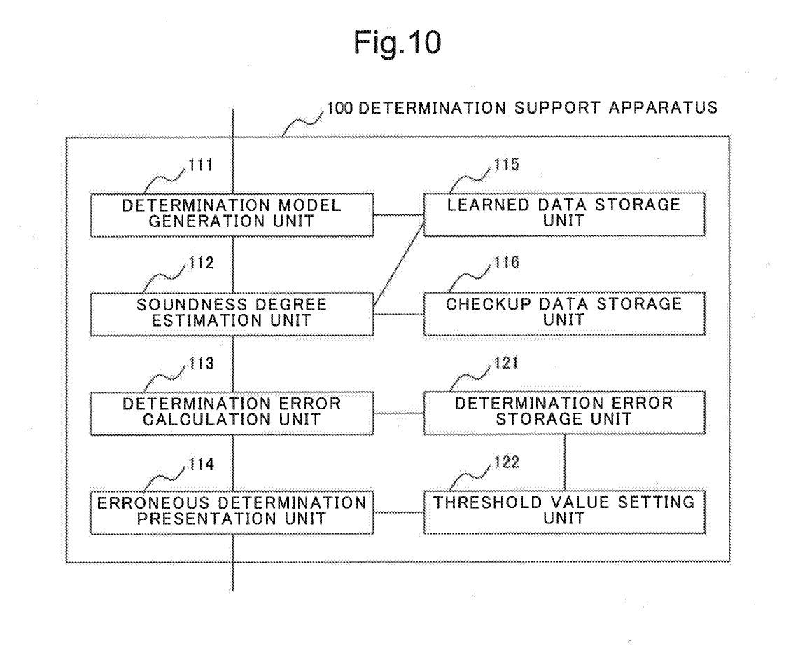

FIG. 10 is a block diagram illustrating a configuration of the determination support apparatus 100 in the second exemplary embodiment.

Referring to FIG. 10, the determination support apparatus 100 in the second exemplary embodiment includes the configuration of the first exemplary embodiment (FIG. 2) and further includes a determination error storage unit 121 and a threshold value setting unit 122.

The soundness degree estimation unit 112 estimates the soundness degree of a learning-object structure included in learned data in addition to estimating the soundness degree of the checkup-object structure.

The determination error calculation unit 113 calculates a determination error regarding the learning-object structure in addition to the determination error regarding the checkup-object structure. The determination error calculation unit 113 saves the determination error regarding the learning-object structure and the determination error regarding the checkup-object structure in the determination error storage unit 121.

The determination error storage unit 121 stores the determination error regarding the learning-object structure and the determination error regarding the checkup-object structure which have been calculated by the determination error calculation unit 113.

The threshold value setting unit 122 sets a threshold value for detecting an erroneous determination candidate. Since the determination error is generally considered to follow a normal distribution, the threshold value setting unit 122 sets a threshold value, for example, on the basis of an average value μ and a standard deviation σ of the determination errors of the learning-object structures read from the determination error storage unit 121. In this case, the threshold value setting unit 122 sets, to the threshold value, for example, a value of μ±3σ that is a reference of a general statistical outlier. Furthermore, the threshold value setting unit 122 may set the threshold value so that the larger the estimated soundness degree of a checkup-object structure is (the lower the soundness indicated by an estimated soundness degree is), the higher the probability of the structure being detected and presented as an erroneous determination candidate becomes (the more likely it is to be determined that there is an erroneous determination possibility). In this case, the threshold value setting unit 122 may set, to the threshold value, a value of μ±3σ/St′ that includes a value obtained by dividing the standard deviation σ by the estimated soundness degree St′ of the checkup-object structure. As a result, the higher the potential risk of erroneous determination is, the higher the probability of the structure being detected and presented as an erroneous determination candidate becomes.

The erroneous determination presentation unit 114 detects an erroneous determination candidate by comparing the determination error for the checkup-object structure with the threshold value calculated by the threshold value setting unit 122.

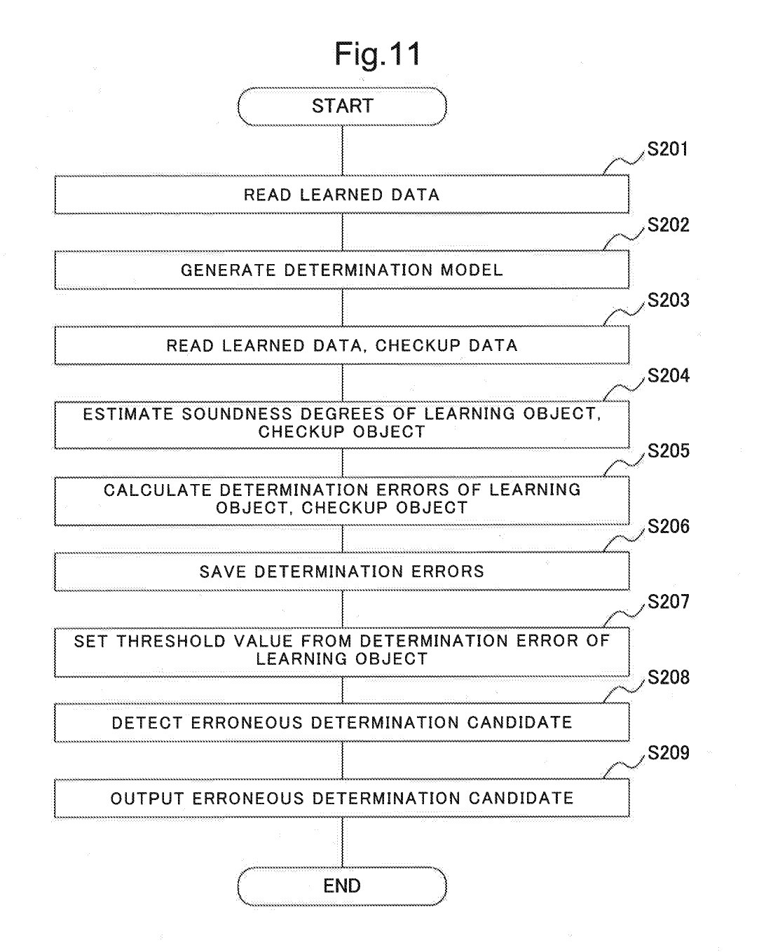

Next, an operation of the determination support apparatus 100 in the second exemplary embodiment will be described. FIG. 11 is a flowchart illustrating the operation of the determination support apparatus 100 in the second exemplary embodiment.

First, the determination model generation unit 111 generates a determination model by using learned data (steps S201 and S202) as in steps S101 and S102 in the first exemplary embodiment.

The soundness degree estimation unit 112 reads learned data from the learned data storage unit 115 and checkup data from the checkup data storage unit 116 (step S203).

The soundness degree estimation unit 112, using the determination model, estimates the soundness degree of a learning-object structure and the soundness degree of a checkup-object structure (step S204).

The determination error calculation unit 113 calculates a determination error regarding the learning-object structure and a determination error regarding the checkup-object structure (step S205). With regard to the learning-object structure, the determination error calculation unit 113 calculates the determination error from a difference between the soundness degree in the learned data and the estimated soundness degree. With regard to the checkup-object structure, the determination error calculation unit 113 calculates the determination error from a difference between the inspector soundness degree in the checkup data and the estimated soundness degree.

The determination error calculation unit 113 saves the determination error regarding the learning-object structure and the determination error regarding the checkup-object structure in the determination error storage unit 121 (step S206).

The threshold value setting unit 122 sets, on the basis of the determination error for the learning-object structure read from the determination error storage unit 121, a threshold value for detecting erroneous determination candidates (step S207).

The erroneous determination presentation unit 114 detects an erroneous determination candidate by comparing the determination error for a checkup-object structure read from the determination error storage unit 121 with the threshold value set in step S207 (step S208).

The erroneous determination presentation unit 114 presents (outputs) the structure ID of the erroneous determination candidate as in step S107 in the first exemplary embodiment (step S209).

Next, a concrete example of the operation of the determination support apparatus 100 in the second exemplary embodiment will be described. It is assumed here that learned data as illustrated in FIG. 5 is stored in the learned data storage unit 115. It is also assumed that checkup data as illustrated in FIG. 6 is stored in the checkup data storage unit 116. It is assumed that the threshold value setting unit 122 uses a threshold value μ+3σ/St′ as the threshold value for detecting erroneous determination candidates.

The determination model generation unit 111 generates a determination model by using the inspection records and the soundness degrees of learning-object structures “1” to “100” included in the learned data as in the concrete example in first exemplary embodiment.

The soundness degree estimation unit 112 calculates estimated soundness degrees regarding the learning-object structures “1” to “100” by using the determination model. Furthermore, the soundness degree estimation unit 112 calculates estimated soundness degrees regarding the checkup-object structures “101” to “104” included in the checkup data by using the determination model as indicated in FIG. 7.

With regard to each of the structures “1” to “100”, the determination error calculation unit 113 calculates a determination error by using the estimated soundness degree thereof and the soundness degree in the learned data. Furthermore, with regard to each of the structures “101” to “104”, the determination error calculation unit 113 calculates a determination error by using the estimated soundness degree thereof and the inspector soundness degree in the checkup data as indicated in FIG. 8.

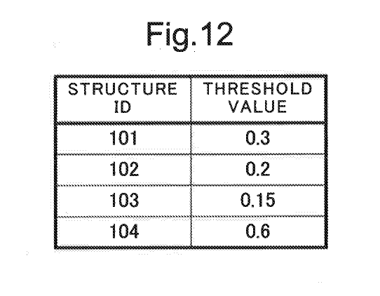

FIG. 12 is a diagram illustrating an example of calculated threshold values in the second exemplary embodiment.

The threshold value setting unit 122 calculates μ=0 and σ=0.2 as an average value and a standard deviation of the determination errors for the learning-object structures “1” to “100”. With regard to each of the checkup-object structures “101” to “104”, the threshold value setting unit 122 calculates a threshold value μ+3σ/St′ by using the estimated soundness degree indicated in FIG. 7, as in FIG. 12.

The erroneous determination presentation unit 114 compares the determination error indicated in FIG. 8 with the threshold value indicated in FIG. 12 with regard to each of the structures “101” to “104”, and detects and presents the structures “102” and “103” as erroneous determination candidates, whose determination errors exceed their respective threshold values.

The operation of the second exemplary embodiment is completed as described above.

Next, advantageous effects of the second exemplary embodiment will be described.

According to the second exemplary embodiment, threshold values for detecting erroneous determination candidates can be easily set. A reason for this is that the threshold value setting unit 122 calculates threshold values on the basis of the determination errors for learning-object structures. Therefore, a threshold value appropriate to a determination model can be set without a need for the user or the like to set the threshold value.

Furthermore, according to the second exemplary embodiment, the threshold value can be adjusted according to the risk of erroneous determination. A reason for this is that the threshold value setting unit 122 calculates the threshold value so that the lower the soundness indicated by the estimated soundness degree of a checkup-object structure is, the more likely it is to be determined that the structure has an erroneous determination possibility.

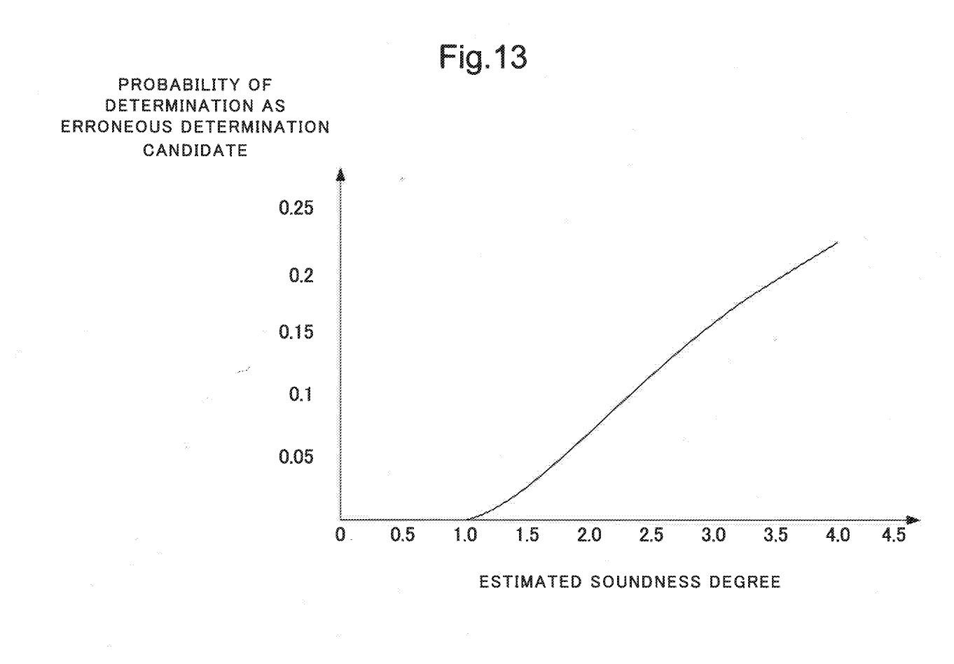

FIG. 13 is a diagram indicating the probability of a checkup-object structure being determined as an erroneous determination candidate (probability of determination as an erroneous determination candidate) against the estimated soundness degree thereof in the second exemplary embodiment. FIG. 13 indicates the probability of a checkup-object structure being determined as an erroneous determination candidate (the probability that the determination error regarding the checkup-object structure exceeds a threshold value μ+3σ/St′) on the assumption that the determination errors regarding learning-object structures follow a normal distribution with an average μ=0 and a standard deviation σ=0.2. As indicated in FIG. 13, as the estimated soundness degree St′ regarding a checkup-object structure is higher, the threshold value is smaller and, therefore, the possibility of the structure being determined as an erroneous determination candidate is higher.

Thus, in the second exemplary embodiment, the threshold value can be easily set and adjusted according to risk, so that the recheck of results of the soundness degree determination can be performed more efficiently than in the first exemplary embodiment.

### Third Exemplary Embodiment

Next, a third exemplary embodiment will be described. The third exemplary embodiment is different from the first exemplary embodiment in that the identifier of an inspector whose reliability degree is low is output.

First, a configuration of a determination support apparatus 100 in the third exemplary embodiment will be described.

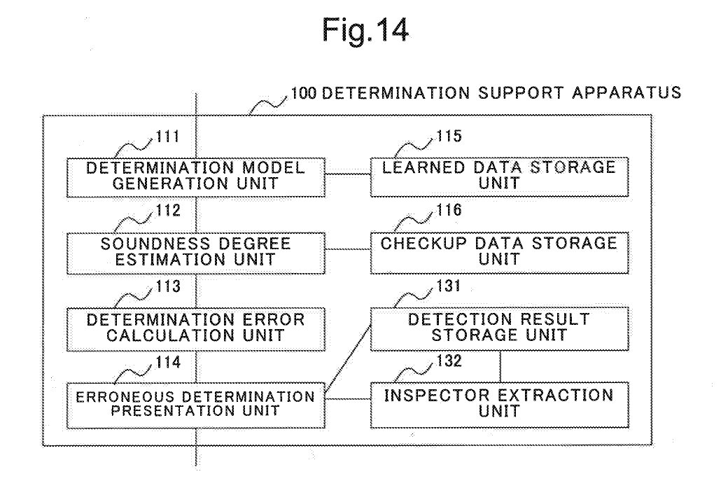

FIG. 14 is a block diagram illustrating a configuration of the determination support apparatus 100 in the third exemplary embodiment.

Referring to FIG. 14, the determination support apparatus 100 in the third exemplary embodiment includes the configuration of the first exemplary embodiment (FIG. 2) and further includes a detection result storage unit 131 and an inspector extraction unit 132.

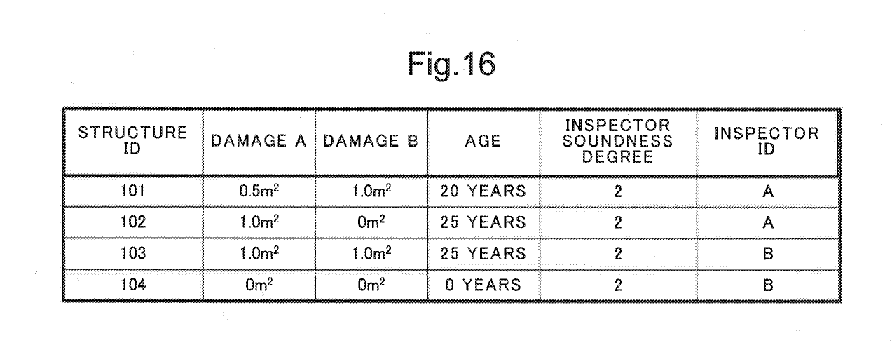

The checkup data in the third exemplary embodiment indicates inspectors in addition to the inspection records on checkup-object structures and the inspector soundness degrees regarding the inspection records. FIG. 16 is a diagram illustrating an example of checkup data in the third exemplary embodiment. In the example in FIG. 16, the checkup data includes, for each of checkup-object structure IDs, an inspection record and the identifier of an inspector who has determined the soundness degree of the structure (inspector ID), which are associated with each other. Each inspector ID may be an inspector's name provided that the name allows the inspector to be uniquely identified. Furthermore, the inspector IDs may be identifiers or names of organizations, such as companies or businesses to which inspectors belong. Furthermore, the inspector IDs may be identifiers or names of groups into which inspectors are classified by preset attributes, for example, their ages, years of experience, and the like.

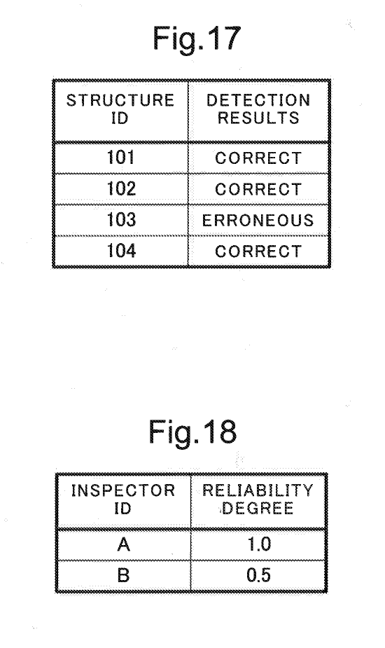

The detection result storage unit 131 stores detection results of the erroneous determination candidates (erroneous determination candidate detection results) provided by the determination error calculation unit 113. FIG. 17 is a diagram illustrating an example of erroneous determination candidate detection results in the third exemplary embodiment. The example in FIG. 17 indicates, separately for each checkup-object structure ID, whether the structure has been detected as an erroneous determination candidate (detection result: “erroneous”) or not (detection result: “correct”) as erroneous determination candidate detection results.

The inspector extraction unit 132 calculates the reliability degree of the inspector of each structure on the basis of the erroneous determination possibility of the soundness degree that the inspector has determined and, according to the calculated reliability degree, extracts the inspector that is to be presented. The inspector extraction unit 132 may present the extracted inspector in a recognizable manner. For example, the inspector extraction unit 132 extracts an inspector whose reliability degree in the soundness degree determination is low (low-reliability inspector), on the basis of the erroneous determination candidate detection results of the structures read from the detection result storage unit 131 and the inspector IDs for the structures included in the checkup data read from the checkup data storage unit 116. The inspector extraction unit 132, for example, calculates (N−Ne)/N as the reliability degree of each inspector, where N is the number of structures for which the inspector has performed soundness degree determination and Ne is the number of structures, among these structures, that have been detected as erroneous determination candidates. Note that when the reliability degree in soundness degree determination can be calculated on the basis of erroneous determination candidate detection results, the inspector extraction unit 132 may calculate the reliability degree by using another mathematical formula. The inspector extraction unit 132 extracts inspectors whose reliability degrees are equal to or less than a preset reliability degree threshold value as low-reliability inspectors. The inspector extraction unit 132 presents the inspector IDs of the extracted low-reliability inspectors to a user or the like via the input/output device 103 or the like. Note that the erroneous determination presentation unit 114 may present, together with erroneous determination candidates, the inspector IDs of the low-reliability inspectors extracted by the inspector extraction unit 132.

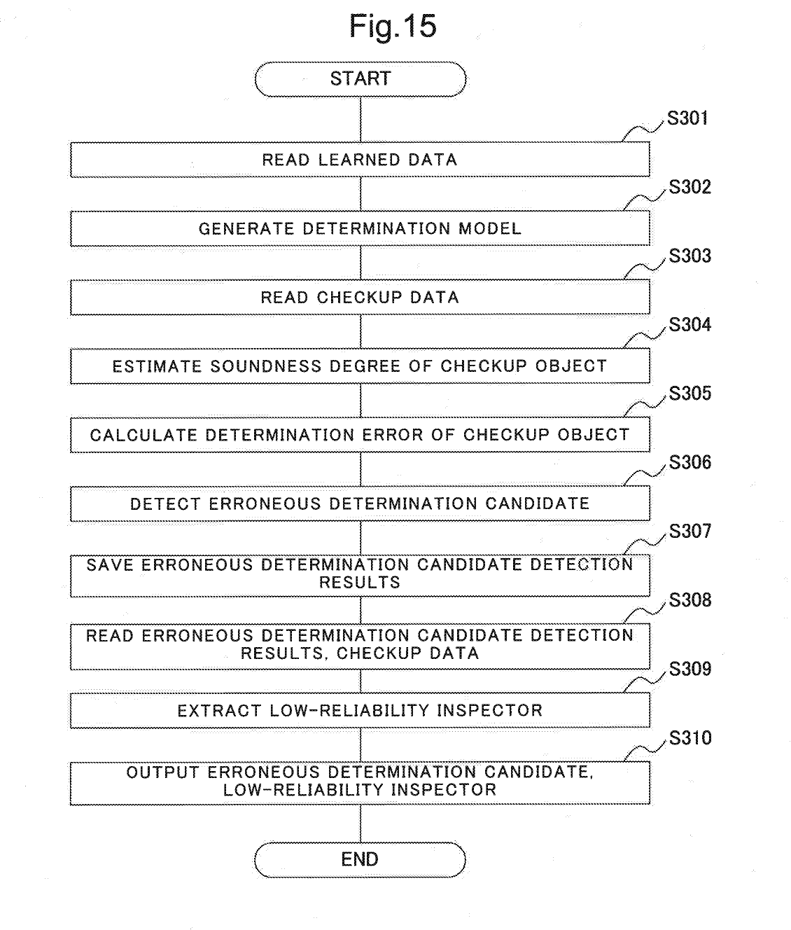

Next, an operation of the determination support apparatus 100 in the third exemplary embodiment will be described. FIG. 15 is a flowchart illustrating the operation of the determination support apparatus 100 in the third exemplary embodiment.

Note that the process (steps S301 to S306) from generation of a determination model by the determination model generation unit 111 to detection of an erroneous determination candidate is the same as in the first exemplary embodiment (step S101 to S106).

The erroneous determination presentation unit 114 saves erroneous determination candidate detection results in the determination error storage unit 121 (step S307).

The inspector extraction unit 132 reads erroneous determination candidate detection results from the determination error storage unit 121 and reads checkup data from the checkup data storage unit 116 (step S308).

The inspector extraction unit 132 extracts low-reliability inspectors on the basis of the erroneous determination candidate detection results and the inspector IDs included in the checkup data (step S309).

The erroneous determination presentation unit 114 presents (outputs) the inspector IDs of the low-reliability inspectors together with the structure IDs of the erroneous determination candidates (step S310).

Next, a concrete example of the operation of the determination support apparatus 100 in the third exemplary embodiment will be described. Here, it is assumed that learned data as illustrated in FIG. 5 is stored in the learned data storage unit 115. It is also assumed that checkup data as illustrated in FIG. 16 is stored in the checkup data storage unit 116. Furthermore, it is assumed that the inspector extraction unit 132 uses (N−Ne)/N as the reliability degree of an inspector. Further, it is assumed that a reliability degree threshold value for detecting low-reliability inspectors has been set to “0.5” in advance by a user or the like.

As in the concrete example in the first exemplary embodiment, the erroneous determination presentation unit 114 detects the structure “103” included in the checkup data in FIG. 16 as an erroneous determination candidate and generates an erroneous determination candidate detection result as in FIG. 17.

FIG. 18 is a diagram illustrating an example of the reliability degrees of inspectors in the third exemplary embodiment.

The inspector extraction unit 132 calculates the reliability degrees of inspectors “A” and “B” as in FIG. 18 by using detection results for the structures “101” to “104” included in the erroneous determination candidate detection results illustrated in FIG. 17 and the inspector IDs for the structures included in the checkup data illustrated in FIG. 16. Then, the inspector extraction unit 132 extracts the inspector “B”, whose reliability degree is equal to or less than the reliability degree threshold value of “0.5”, as a low reliability inspector.

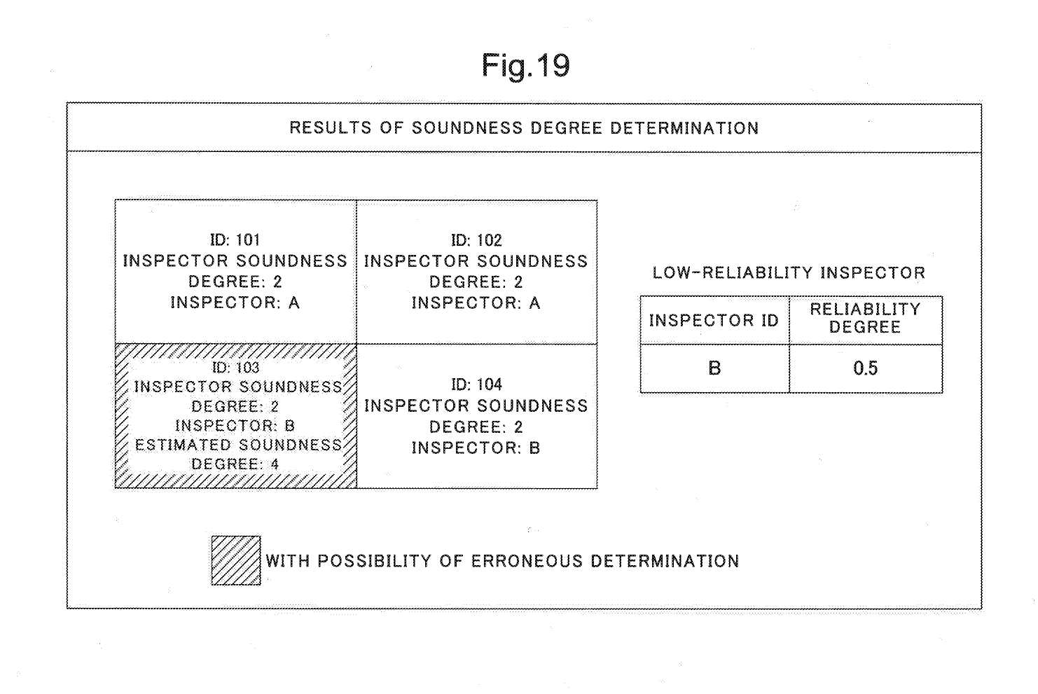

FIG. 19 is a diagram illustrating an example of an output screen displaying erroneous determination candidates in the third exemplary embodiment. The output screen in FIG. 19 displays the inspector ID “B” of the inspector extracted as a low-reliability inspector and the reliability degree “0.5” of the inspector. Furthermore, the output screen displays, in association with each of the structures “101” to “104”, the inspector soundness degree of the structure and the inspector ID of the inspector who has determined the soundness degree. With regard to the structure “103” detected as an erroneous determination candidate, an estimated soundness degree is displayed as well.

The erroneous determination presentation unit 114 presents (outputs) the output screen illustrated in FIG. 19 to a user or the like.

On the basis of the output screen in FIG. 19, the user or the like can recheck results of the soundness degree determination with a priority given to the structures whose soundness degrees have been determined by the low-reliability inspectors.

Furthermore, on the basis of results of extraction of low-reliability inspectors, the inspectors may be trained. In this case, the erroneous determination presentation unit 114 presents for each extracted low-reliability inspector the estimated soundness degree and the inspector soundness degrees determined by the inspector as in the output screen illustrated in FIG. 19. Therefore, the low-reliability inspectors can compare the soundness degrees determined by the low-reliability inspectors with the estimated soundness degrees equivalent to the determination results provided by skilled experts. Therefore the low-reliability inspectors can recognize differences from the skilled experts.

The operation of the third exemplary embodiment is completed as described above.

Next, advantageous effects of the third exemplary embodiment will be described.

According to the third exemplary embodiment, the user can know of inspectors (persons or organizations) that have such low reliability degrees as to frequently make erroneous determination. A reason for this is that the inspector extraction unit 132 extracts inspectors who are low in the reliability degree in the soundness degree determination on the basis of the erroneous determination candidate detection results regarding the structures and the IDs of the inspectors of the structures. Therefore, the user can more efficiently recheck the results of the soundness degree determination by narrowing down to the structures whose soundness degrees have been determined by low-reliability inspectors. Furthermore, the user can better the reliability degree of the soundness degree determination by carrying out education or the like of the low-reliability inspectors preferentially on the soundness degree determination, or the like.

Note that although in the third exemplary embodiment, the reliability degree is compared with a reliability degree threshold value and inspectors whose reliability degrees are equal to or lower than the reliability degree threshold value (inspectors whose reliability degrees are low) are extracted, inspectors whose reliability degrees are equal to or higher than the reliability degree threshold value (inspectors whose reliability degrees are high) may be extracted.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An information processing apparatus comprising a processor configured to:
estimate a soundness degree of a checkup-object structure from an inspection result of the checkup-object structure, based on a model generated by using an inspection result of a learning-object structure and a soundness degree of the learning-object structure; and
present in a recognizable manner an erroneous determination possibility indicating a possibility that a soundness degree determined from the inspection result of the checkup-object structure is erroneous, based on the estimated soundness degree of the checkup-object structure.

2. The information processing apparatus according to claim 1, the processor further configured to:
calculate a determination error of the determined soundness degree for the checkup-object structure based on the estimated soundness degree of the checkup-object structure, wherein
the processor configured to present the erroneous determination possibility, based on a result of comparison between the calculated determination error and a preset threshold value.

3. The information processing apparatus according to claim 2, wherein
the processor calculate the determination error that is a difference between the estimated soundness degree of the checkup-object structure and the determined soundness degree of the checkup-object structure.

4. The information processing apparatus according to claim 2, the processor further configured to:
set the threshold value, based on a difference between the soundness degree of the learning-object structure estimated based on the model and the soundness degree determined from an inspection result of the learning-object structure.

5. The information processing apparatus according to claim 3, wherein
the processor configured to set the threshold value so that as soundness indicated by the estimated soundness degree of the checkup-object structure is lower, probability of the erroneous determination possibility being presented is higher.

6. The information processing apparatus according to claim 3, wherein
the processor configured to set the threshold value so that the erroneous determination possibility is presented when soundness indicated by the determined soundness degree of the checkup-object structure is higher than soundness indicated by the estimated soundness degree of the checkup-object structure.

7. The information processing apparatus according to claim 1, the processor further configured to:
calculate a reliability degree of an inspector of a structure, based on an erroneous determination possibility regarding a soundness degree determined by the inspector; and
extract an inspector that is to be presented, based on the calculated reliability degree.

8. The information processing apparatus according to claim 7, wherein the processor configured to present the extracted inspector in a recognizable manner.

9. An information processing method comprising:
estimating a soundness degree of a checkup-object structure from an inspection result of the checkup-object structure, based on a model generated by using an inspection result of a learning-object structure and a soundness degree of the learning-object structure; and
presenting, in a recognizable manner, an erroneous determination possibility indicating a possibility that a soundness degree determined from an inspection result of the checkup-object structure is erroneous, based on the estimated soundness degree of the checkup-object structure.

10. A non-temporary storage medium storing a program that causes a computer to execute the processes of:
estimating a soundness degree of a checkup-object structure from an inspection result of the checkup-object structure, based on a model generated by using an inspection result of a learning-object structure and a soundness degree of the learning-object structure; and
presenting, in a recognizable manner, an erroneous determination possibility indicating a possibility that a soundness degree determined from an inspection result of the checkup-object structure is erroneous, based on the estimated soundness degree of the checkup-object structure.
